(19) United States
(12) Patent Application Publication
(10) Pub. No.: US 2017/0024054 A1
(43) Pub. Date: Jan. 26, 2017

(54) METHOD FOR TACTILELY OUTPUTTING DATA ON A COMPUTING DEVICE

(71) Applicant: Tactus Technology, Inc., Fremont, CA (US)

(72) Inventors: Micah Yairi, Daly City, CA (US); Craig Ciesla, Fremont, CA (US); Radhakrishnan Parthasarathy, Fremont, CA (US)

(21) Appl. No.: 15/068,400

(22) Filed: Mar. 11, 2016

Related U.S. Application Data
(60) Provisional application No. 62/131,741, filed on Mar. 11, 2015.

(51) Int. Cl. G06F 3/041; G06F 1/16; G06F 3/01

(52) U.S. Cl. CPC G06F 3/0416; G06F 3/016; G06F 1/163

(57) ABSTRACT

A device having a dynamic tactile interface communicates with an external electronic device to provide tactile output (e.g., tactile display) based on communication with the external electronic device. Data is tactilely displayed on a computing device. Data is received from an external electronic device. The data is converted into a tangible data structure and a portion of a dynamic tactile layer is deformed corresponding to the tangible data structure. The dynamic tactile layer is arranged over a surface of the computing device and includes a set of deformable regions, wherein each deformable region deforms into an elevated tactile formation. The portion of the dynamic tactile layer includes a subset of deformable regions in the set of deformable regions.

### CROSS-REFERENCE TO RELATED APPLICATIONS

This application claims the benefit of U.S. Provisional Application No. 62/131,741, filed Mar. 11, 2015, which is incorporated in its entirety by this reference.

This application is related to U.S. patent application Ser. No. 11/969,848, filed on Jan. 4, 2008; U.S. patent application Ser. No. 13/414,589, filed Mar. 7, 2012; U.S. patent application Ser. No. 13/456,010, filed Apr. 25, 2012;U.S. patent application Ser. No. 13/456,031, filed Apr. 25, 2012; U.S. patent application Ser. No. 13/465,737, filed May 7, 2012; and U.S. patent application Ser. No. 13/465,772, filed May 7, 2012, U.S. patent application Ser. No. 14/471,889, filed Aug. 28, 2014, all of which are incorporated in their entireties by this reference.

### TECHNICAL FIELD

This invention relates generally to computing devices, and more specifically to a new and useful method for tactilely outputting data on a computing device.

### BRIEF DESCRIPTION OF THE FIGURES

FIG. 1 is a flowchart representation of a method of one embodiment of the invention;

FIG. 2 is a flowchart representation of one variation of the method;

FIG. 3 is a flowchart representation of one variation of the method;

FIG. 4 is a flowchart representation of one variation of the method;

FIGS. 5A and 5B are schematic representations of a dynamic tactile interface in accordance with one variation of the method;

FIGS. 6A, 6B, 6C, and 6D are schematic representations of a dynamic tactile interface in accordance with one variation of the method; and

FIGS. 7A, 7B, 7C, 7D, 7E, and 7F are schematic representations of a dynamic tactile interface in accordance with one variation of the method.

### DESCRIPTION OF THE EMBODIMENTS

The following description of the embodiment of the invention is not intended to limit the invention to these embodiments, but rather to enable any person skilled in the art to make and use this invention.

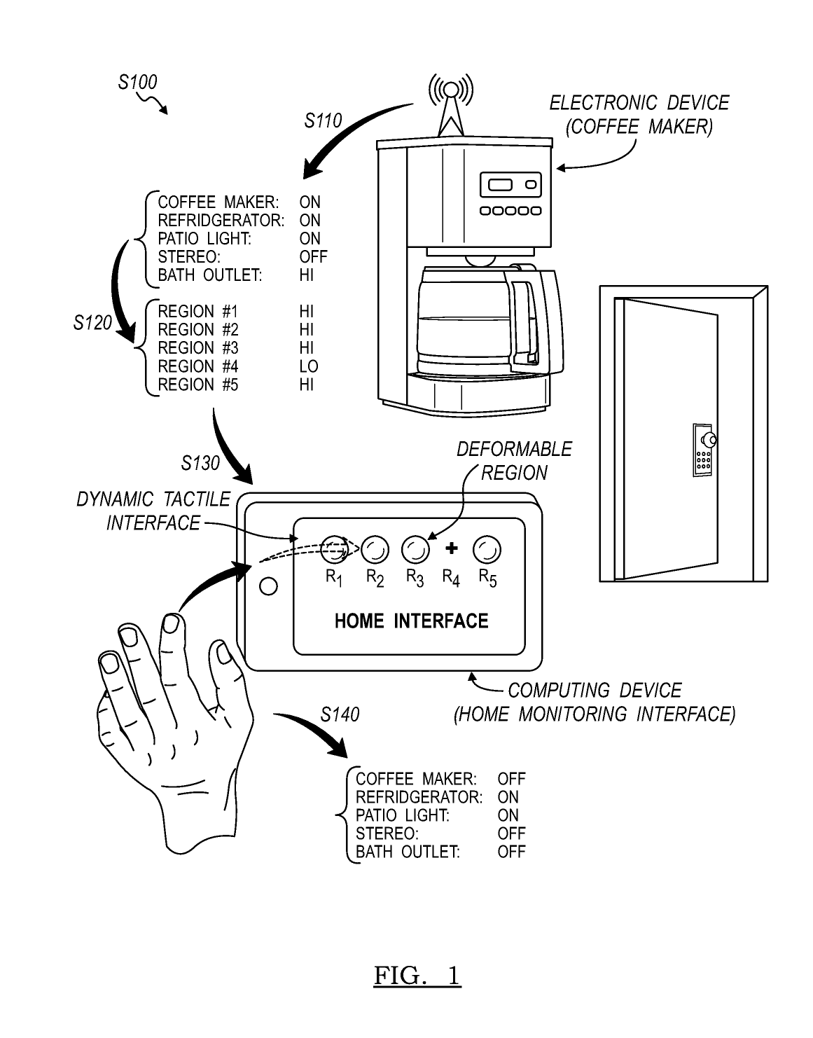

As shown in FIG. 1, a method S100 for tactilely displaying data on a computing device includes: receiving data from an external electronic device in Block S110; converting the data into a tangible data structure in Block S120; and deforming a portion of a dynamic tactile layer corresponding to the tangible data structure in Block S130, the dynamic tactile layer arranged over a surface of the computing device and including a set of deformable regions, each deformable region configured to deform into an elevated tactile formation, the portion of the dynamic tactile layer including a subset of deformable regions in the set of deformable regions. In some instances, each deformable region may be elevated, recessed, or angled.

Generally, the method can be implemented by a computing device wirelessly connected to an external electronic device to tactilely display data collected or received by the external electronic device. The computing device can be a smartphone, a tablet, a watch, a vehicle console, a desktop computer, a laptop computer, a television, a personal data assistance (PDA), a personal navigation device, a personal media or music player, a camera, a watch, a residential or commercial thermostat, a home or residential alarm system, a home or residential building or appliance monitor interface, or any other suitable computing device. The electronic device can similarly be a wearable sensor, an external or internal (i.e. in-cabin) sensor on a vehicle, an appliance, a residential or commercial building monitor sensor (e.g., a smoke detector, a door or window sensor), a mobile or static computing device, or any other suitable sensor or device. The electronic device can be implemented on or within clothing, a medical device, interior or exterior of a glove, exterior of a car, a musical instrument, and other elements that have a surface. The computing device and the electronic device can communicate wirelessly, such as over a Wi-Fi, cellular, Bluetooth, Zigbee, XBee, or other communication protocol. Alternatively, the computing device and the electronic device can communicate over a wired connection. However, the computing device and the electronic device can be any other suitable device or devices that communicate with each other in any other suitable way.

The computing device includes a dynamic tactile interface, as described in U.S. patent application Ser. No. 11/969,848, U.S. patent application Ser. No. 13/414,589, U.S. patent application Ser. No. 13/456,010, U.S. patent application Ser. No. 13/456,031, U.S. patent application Ser. No. 13/465,737, and U.S. patent application Ser. No. 13/465,772. Generally, the dynamic tactile interface can include selectively reconfigurable deformable regions that define one or more buttons, a tixel (pixel-level tactile) display, or other suitable interface that can be physically reconfigured into tactilely-distinguishable regions to tactilely communicate data to a user. The dynamic tactile interface can incorporate a fluid-based system to expand and retract a deformable region and/or a non-fluid based system.

Blocks of the method can be implemented on the computing device, such as by a native application or applet or as system-level functionality accessible to various programs or applications executing on the computing device. One or more Blocks of the method can additionally or alternatively be implemented on or by the electronic device, a remote server, a computer network, etc. The method can transmit data from a first computing device to a second computing device, from one computing device to multiple computing devices, and/or from multiple computing device to one computing device.

Block S110 of the method recites receiving data from an external electronic device. Generally, Block S110 functions to receive sensor data collected by the electronic device, wherein the data can be implemented physically in Block S130 according to a tangible data structure generated in Block S120.

In some instances, data other than sensor data may be received by the computing device from the remote electronic device. The data may include an instruction generated by the remote electronic device based on sensor data received by the remote electronic device. The instruction may be received by a processor at the computing device and executed to perform an operation with respect to the tactile layer, such as for example to expand a particular deformable region. The data may also include a signal generated in response to sensor data received by the remote electronic device. The signal may specify a state of the remote electronic device, information regarding a component of the remote electronic device, or other information. For example, an “on” or high signal from a smart appliance, such as a refrigerator, dishwasher, coffee maker, TV, music player, router, modem, or other device that can communicate with other devices, may indicate that the particular appliance is on. An “off’ or low signal from a smart appliance may indicate that the particular appliance is off, in a sleep or power saving mode, or in some other mode other than a power on mode.

In some instances, the data sent by a remote electronic device may include deformable region parameters. A deformable region parameter may specify an aspect of a deformable region. An aspect of a deformable region may include a pressure associated with the deformable region, a temperature associated with the deformable region, a state of the deformable region (expanded, slanted, retracted, or flush), a height of expansion or depth of retraction of the deformable region, a period of time for which a deformable region should be deformed, a firmness value, a pulsing speed value, a return value, or some other aspect of a deformable region. In some instances, a deformable region parameter may identify the location or identification of a particular deformable region or set of deformable regions. In some instances, the deformable region parameter may include a return value to return to the remote electronic device based on input received at the deformable region. For example, a deformable region parameter may specify that a value of 0 is to be returned if no input is received within a time period, a value of 1 is to be returned when an input of a first pressure is received, and a value of 2 is to be returned when an input of a second pressure is received.

The computing device may receive the deformable region parameter and create a tangible data structure from the deformable region parameter. For example, for a deformable region parameter that specifies a deformable region is to be expanded to a height of 3 mm, the processor may generate an instruction to a displacement device that fills a cavity associated with the deformable region. The cavity may be filled by the displacement device to expand the deformable region to a height specified by the deformable region parameter—in this example, a height of 3 mm.

A deformable region parameter may be received by a computer device in response to one or more of several events. For example, a message with a deformable region parameter may be sent periodically from a remote electronic device. The deformable region parameter in the periodic message may be the same parameter with a current value, may be a different parameter that is rotated among several populated messages. The deformable region parameter can be provided in response to an event that occurs at the remote electronic device. For example, the remote electronic device may have one or more sensors, logic, or other means for detecting an event. For example, in the context of a car, the event may be whether or not a particular seat belt is buckled, the speed of the car, an amount of gas in a car, an oil pressure, tire pressure, and other detectable events. In the context of a smart appliance such as a refrigerator, the event may be the power on or power off of the refrigerator, a water filter status, detection that a refrigerator door was left open, and other events. In some instances, the computing device may request a status or other information for an external electronic device. For example, a status of a remote smart appliance may be queried by the computing device periodically or in response to an event at the computing device. The event at the computing device may be a request from a user as to the status of the appliance (i.e., remote electronic device).

In some instances, a deformable region parameter may specify a color or fluid with which to expand a deformable region. The dynamic tactile layer may have one or more displacement devices that displace fluids associated with different colors. The fluids may include dyes, or may include a clear fluid with metal particles, nanoparticles or other content. A clear fluid with, for example, a particular nanoparticle material may fluoresce light at a wavelength, thereby appearing to be a particular color when viewed in light. As such, a deformable region parameter may specify a color for a deformable region, which would ultimately result in releasing dye, a suitable fluid with nanoparticles, or other fluid with content that would achieve the color specified in the deformable region parameter.

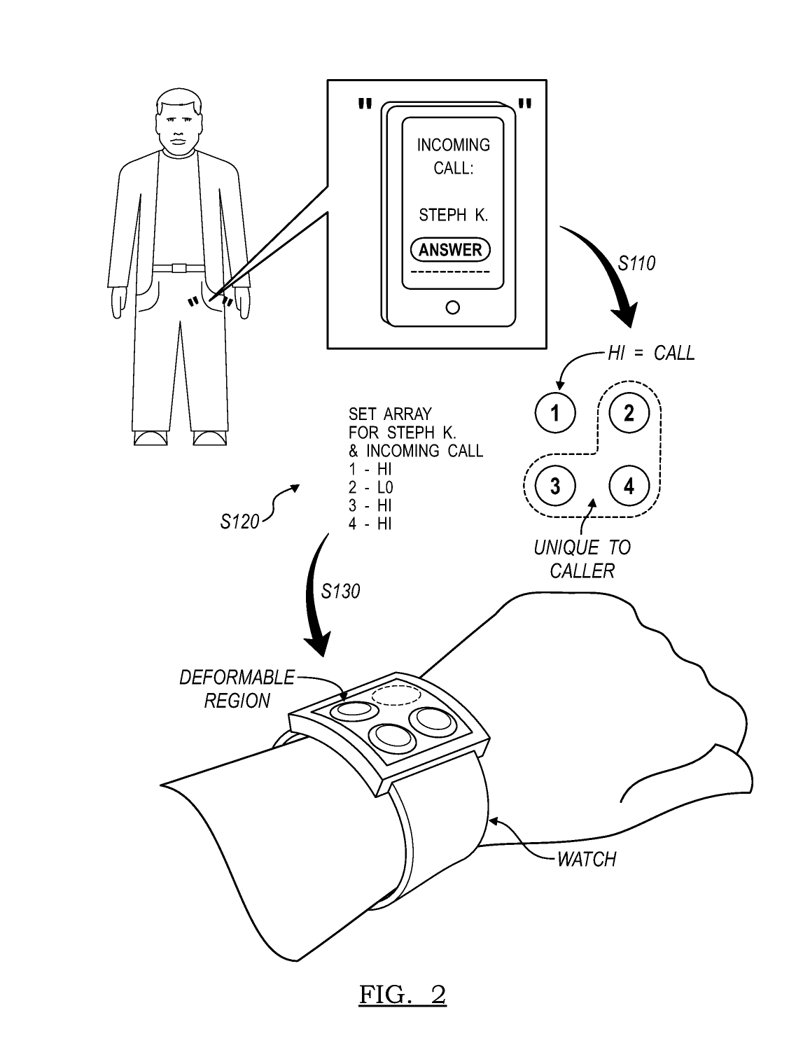

As shown in FIG. 2, in one example implementation in which the electronic device is a cellular phone and the computing device is a watch, Block S110, executing on the watch, can wirelessly receive call data from the cellular phone when a call to the cellular phone is made. Block S110 can similarly receive data, from the cellular phone, in response to a text message, email, alarm, calendar alert, or other notification on the cellular phone. In this example implementation, Block S110, executing on the computing device, can receive the data wirelessly from the electronic device, such as over a Wi-Fi, cellular, or Bluetooth communication protocol.

As shown in FIG. 1, in another example implementation in which the electronic device is a home appliance and the computing device is a home monitoring interface with a touchscreen and a dynamic tactile interface, Block S110, executing on the home monitoring interface, receives a state of the appliance (e.g., ON, OFF, standby mode, sleep mode), such as on a regular schedule (e.g., every minute), when requested by the user through the home monitoring interface, or when the state of the appliance changes. In this example implementation, Block S110, executing on the computing device, can receive the data from the electronic device over a wired connection or over a wireless connection. Block S110 can also receive the data directly from the electronic device or indirectly from the electronic device, such as through a wireless router, a remote server, or a home monitoring system. However, Block S110 can function in any other way to receive data from the external electronic device.

Block S120 of the method recites converting the data into a tangible data structure. Generally, Block S120 functions to transform digital data received in Block S110 into a control command for the dynamic tactile interface, wherein Block S130 can implement the tangible data structure to physically (i.e. tactilely) communicate the data to the user.

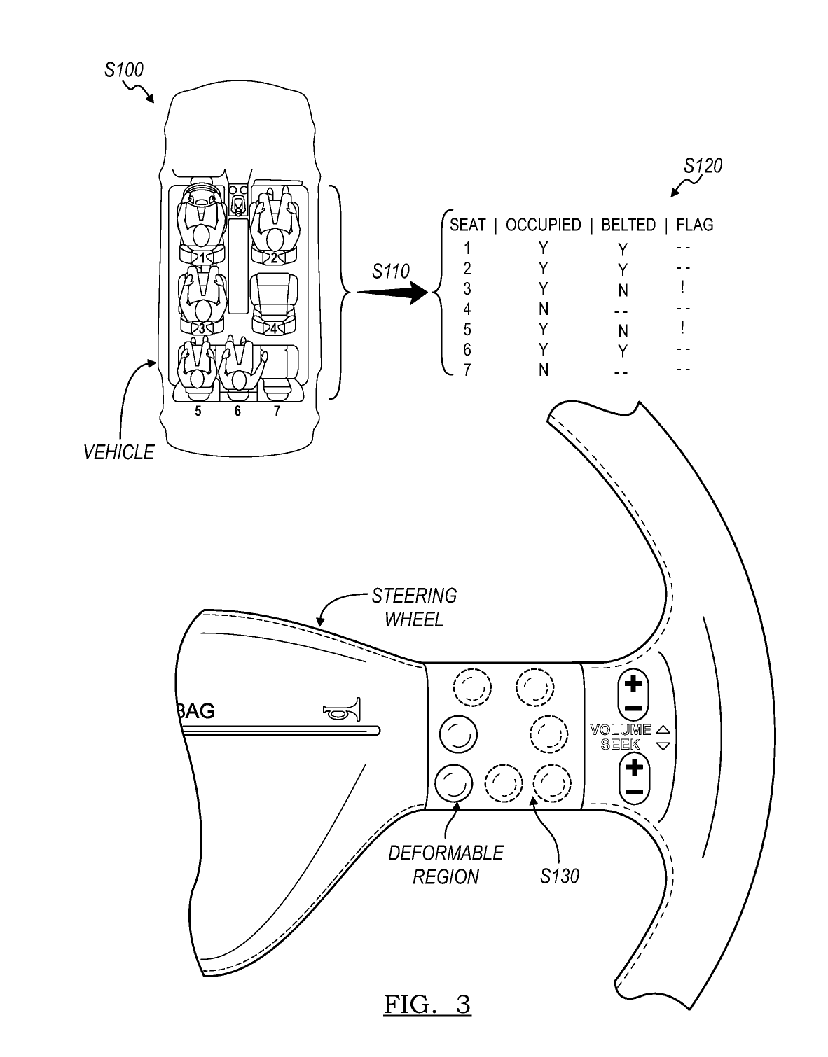

As shown in FIG. 3, in one example implementation in which the computing device is arranged in a vehicle and coupled to a dynamic tactile interface arranged on a steering wheel or center console in the vehicle's cabin, Block S110 can receive seat vehicle occupancy from seat occupancy sensors arranged in the seats of the vehicle. Block S110 can further receive seatbelt states from seatbelt sensors adjacent the seats in the vehicle, and Block S120 can compare vehicle seat occupancy and seatbelt states to specify an expanded deformable region of the dynamic tactile interface for each occupied seat without a buckled seatbelt. For example, Block S120 can specify expanded or retracted settings for each deformable region in an array of deformable regions wherein the arrangement of the deformable regions on the dynamic tactile interface mimics the seating arranged in the vehicle, such as a “2” arrangement for a sports coupe, a “2+3” arranged for a standard-sized sedan, and a “2+2+3” arrangement for a minivan (shown in FIG. 3). In this example implementation, the method can enable a driver of the vehicle to run her fingers over the dynamic tactile interface to quickly ascertain if and where occupants in the vehicle are seated without a buckled seatbelt.

Different quantities and arrangements of deformable regions may be provided at different times. The quantities and arrangements of deformable regions may be provided when they are most useful or needed. This may be determined by one or more sensors associated with electronic device, the computing device, or some other device. For example, with respect to a steering wheel, an electronic device within the automobile may detect when the car achieves a certain speed. Once the automobile achieves a certain speed, such as for example a highway speed of 50 miles an hour, a deformable region on the steering wheel may expand above the surface of the steering wheel. The deformable region that expands upon reaching a certain freeway speed may enable a user to indicate whether the user would like to engage cruise control. By expanding the deformable region when the automobile achieves a certain speed associated with a freeway, the cruise control is only provided when it is useful. While a user is driving around town at speeds up to 25 miles an hour, constantly stopping and proceeding between stoplights, stop signs, and bumper-to-bumper traffic, cruise control is not useful in such situations and the deformable region associated with selecting cruise control would not be provided to the user.

In the above cruise control example, if a user selects a deformable region that expands when a user achieves a speed that is suitable for cruise control, wherein selection may include touch, depression, a swipe, or some other input a the deformable region or otherwise detectable input, a series of additional deformable regions would expand on the surface of the steering wheel. The additional deformable regions would correlate to cruise control functions, such as set speed, increase speed, decrease speed, and stop cruise control. If a user does not press or otherwise select the first deformable region that expands when the user achieves the threshold speed, the additional deformable regions would not expand and thereby appear on the surface of the steering wheel, reducing the number of deformable region “buttons” on the steering wheel.

In some instances, the user may provide different inputs to the first deformable region to indicate whether the user would like to proceed with cruise control or not. For example, when the automobile approaches a highway speed, the user may depress the deformable region once to indicate the user would like to utilize cruise control and depress the deformable region twice to indicate user would not like to engage cruise control. If the user engages the deformable region once, additional deformable regions would expand from the surface of the steering wheel to enable the user to perform cruise control functions. If the user engages the deformable region twice, that deformable region would retract until it was flush with the surface of the steering wheel.

In addition to cruise control functionality, the present technology may be used to otherwise shape a steering wheel on an automobile in response to a signal received from a device within the automobile. For example, a global positioning system (GPS) system within the automobile may determine that for a road currently traveled on by the automobile, portions of the road ahead have significant curves. In response to detecting that an upcoming portion of a road is curved, deformable regions on the surface of the steering wheel may expand in order to provide a better grip for user. For example, multiple deformable regions may expand to provide notches on the outer surface of the steering wheel that conform to a user's hand, allowing the user's hand to have a better grip on the steering wheel as the user navigates turns in the road.

Though inputs at a deformable region have been discussed with respect to depressing the deformable region, other inputs are possible as well. For example, a user may swipe a finger over the surface of the steering wheel to perform a gesture. Additionally, the user may simply touch the expanded deformable region, wherein a touch sensor may detect the touch without regard to any pressure applied to the deformable region.

The feature of depressing a first deformable region to cause additional deformable regions to appear may be applied to many types of devices and applications other than a steering wheel surface. For example, on a smart phone, a first deformable region may appear when an incoming call is received. User may select answer the call by depressing a deformable region that appears while the phone is ringing. If the user depresses the deformable region while the phone is ringing, additional deformable regions may appear to controller call, such as for example 2 new to the call, put the call on a loudspeaker, hang up the call, and other functions.

As in the example implementation described above in which the electronic device is a cellular phone and the computing device is a watch, Block S110 can wirelessly receive the identity of a caller, from the cellular phone, when a call to the cellular phone is initiated, as shown in FIG. 2. Block S120 can subsequently find the caller in a database of callers, based on the received identity, and select a tangible data structure paired with the caller in the database. In an example in which the dynamic tactile interface includes a two-by-two array of deformable regions, as shown in FIG. 2, the user can set seven “favorite” callers, wherein each caller is assigned a unique combination of deformable region settings or “address” on the dynamic tactile interface. In this example, when Block S110 receives data indicating a phone call on the computing device, Block S120 can specify that a first deformable region is expanded to indicate a phone call and then specify the state of each of a second, third, and fourth deformable region according to a unique predefined address if the caller is identified as a favorite caller, or Block S120 can specify another unique combination of settings for the second, third, and fourth deformable regions according to a call from a caller not in the favorites list, such as the first deformable region in the expanded setting and each of the second, third, and fourth deformable regions in the retracted setting. Furthermore, Block S120 can specify a unique tangible data structure (or “address”) of the deformable regions of the dynamic tactile interface to indicate an email, a SMS text message, a calendar alert, an alarm, and/or any other notification received from the cellular phone. Therefore, in this example implementation, Block S120 can convert the data into a tangible data structure that, when implemented on the dynamic tactile interface in Block S130, can communicate relevant information substantially in real-time to a user without requiring the user to pull his cellular phone out of his pocket, unlock it, and visually access the notification. Rather, the method enables the computing device (i.e. the watch in this example implementation) to communicate with the electronic device (i.e. the cellular phone in this example implementation) and thus tactilely display relevant information such that the user can discreetly touch his watch to retrieve abbreviated information pertaining to a call, message, etc. If the user decides that the notification is timely, he can then retrieve the cellular phone to answer the phone call, access the full message, etc.

As in the example implementation described above in which the computing device is a home monitoring interface, Block S120 can receive the status of various appliances in the home and specify the state of each deformable region of the dynamic tactile interface according to the appliance statuses. For example, the home monitoring interface can display a map of the home, and various deformable regions of the dynamic tactile interface can correspond to one or more appliances and/or outlets in the home. In this example, if Block S110 receives data specifying that a coffee maker in the kitchen is on and an outlet in the bathroom (often used to power a curling iron) is drawing current, Block S120 can specify expanded settings for both the deformable regions corresponding to the coffee maker and to the outlet, as shown in FIG. 1. Block S120 can thus specify a setting for a deformable region according to a respective appliance or outlet that is deemed undesirable to remain in a current state for an extended period of time. Similarly, Block S120 can specify a setting for a deformable region based on an abnormal function of a respective appliance or outlet. For example, if Block S110 does not receive data from a refrigerator as expected, Block S120 can determine that the refrigerator is broken, that a respective outlet is not functioning properly, or that a respective circuit breaker has switched, and Block S120 thus specify an expanded setting for a deformable region corresponding to the refrigerator or outlet, thereby enabling Block S130 to tactilely display an alarm to a user. In another example, Block S110 can receive light switch and/or light bulb states within the home, and Block S120 can specify a number of deformable regions on the dynamic tactile interface to expand based on the number of lights currently “ON” in the home. Similarly, Block S110 can receive a current home power consumption, such as from a digital power meter, and Block S120 can compare the current home power consumption to a baseline power consumption and thus specify a number of deformable regions on the dynamic tactile interface to expand based on current power consumption over the baselines. Block S120 can further set a pressure and/or height of one or more expanded deformable regions according to a power consumption, according to an amount of time that an appliance has been on or off, or according to any other relevant factor. In any of the foregoing examples, the home monitoring interface can be installed or arranged proximal a front door of the home, thus enabling the user to quickly run a hand over the dynamic tactile interface to comprehend home- and appliance-related data substantially on the fly and without necessitating visual attention. For example, the user can run his hand over the dynamic tactile interface quickly before leaving the home to ensure that nothing is awry or out of the ordinary, and the user can run his hand over the dynamic tactile interface quickly when reentering the home to determine if the state of any appliance or home system has changed.

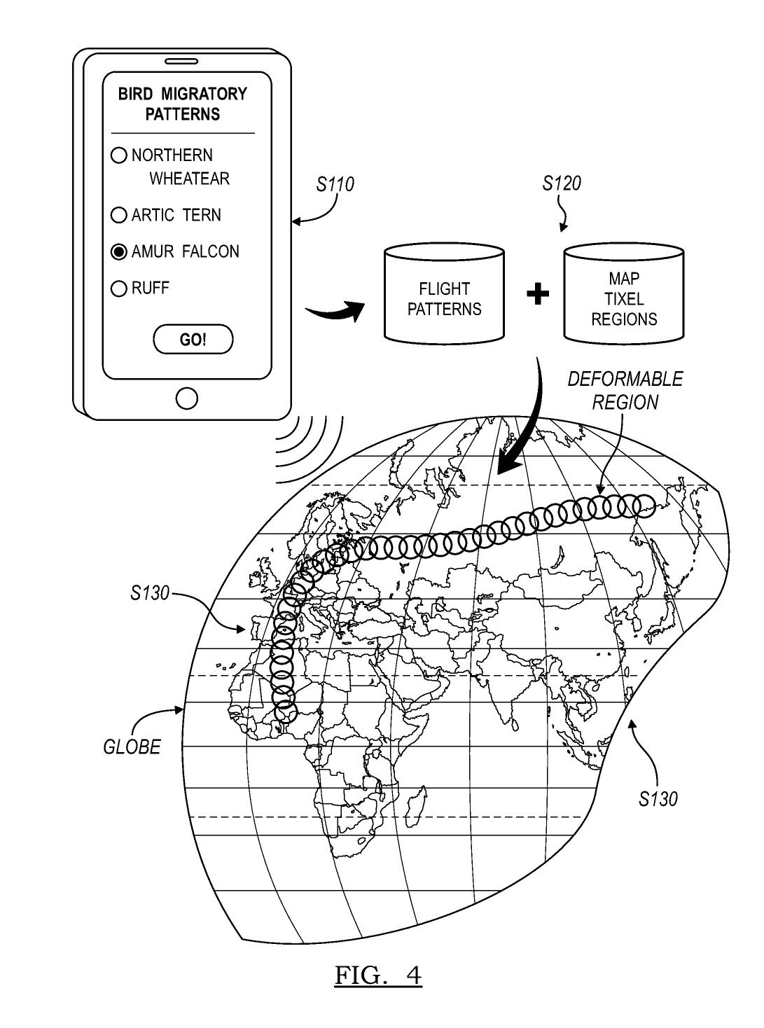

As shown in FIG. 4, in another example implementation, the electronic device includes a smartphone executing a native geography application, and the computing device is a world globe incorporating a dynamic tactile interface over its surface, wherein the electronic device controls the dynamic tactile interface on the world globe. In this example implementation, Block S110 can receive a location or path selection (e.g., country, capital city, trans-Atlantic flight path, bird migratory pattern, etc.) from the user through the native geography application, and Block S120, also executing on the electronic device, can transform the location or pattern into the tangible data structure that includes a coordinate of one or more deformable regions on the dynamic tactile interface to expand. Block S130 can subsequently implement the tangible data structure to tactilely communicate the location or path on the world globe.

In yet another example implementation, the electronic device can be a touch sensor or camera configured to detect a touch on a glass surface, such as a display window or display case at a department store, and the computing device can be a controller for the dynamic tactile interface arranged over the exterior of the glass surface and tactilely accessible to a user. In this example implementation, Block S110 can receive a location of a user input, such as a touch, on the glass surface, and Block S120, executing on the controller, can analyze the touch to specify a setting of one or more deformable regions on the dynamic tactile interface based on the user input. Block S120 can further cooperate with a display driver to project an image, aligned with one or more deformable regions, onto the glass surface. Thus, in this example implementation, Block S120 can specify the state of various regions of the dynamic tactile interface based on a user input onto a display window or display case. However, Block S120 can function in any other way and in any other application to convert data received in Block S110 into a tangible data structure implemented by Block S130 to tactilely communicate information to a user.

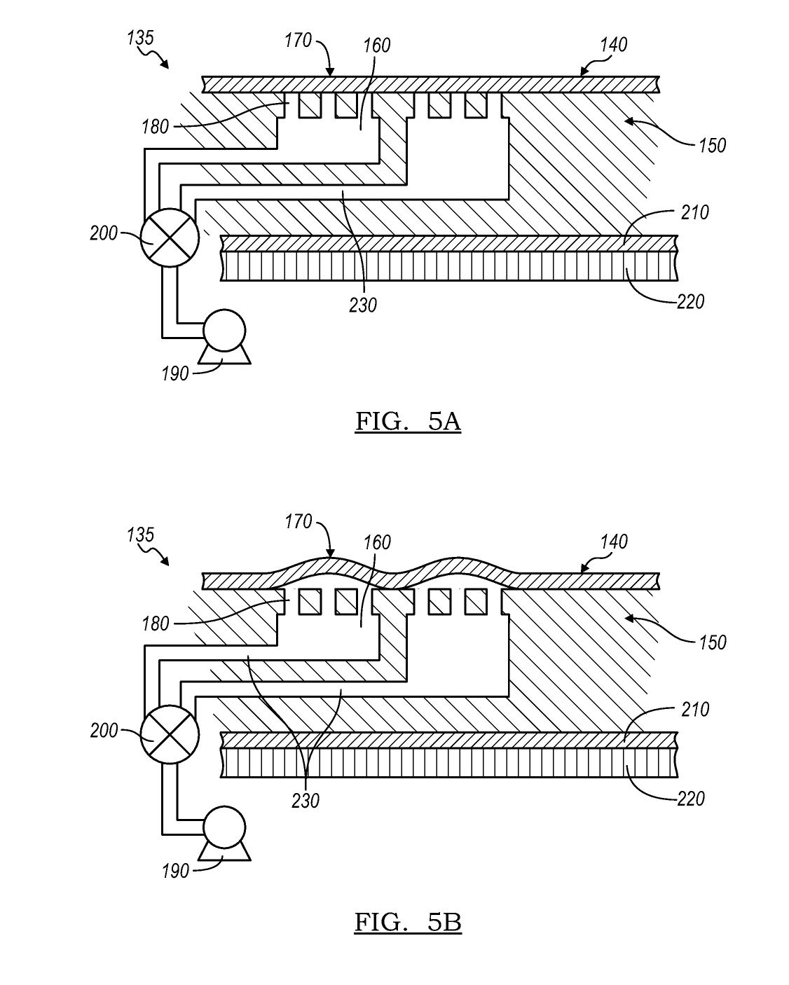

Block S130 of the method recites outwardly deforming a portion of a dynamic tactile layer corresponding to the tangible data structure, the dynamic tactile layer arranged on a surface of the computing device and including a set of deformable regions, each deformable region configured to deform into an elevated tactile formation, the portion of the dynamic tactile layer including a subset of deformable regions in the set of deformable regions. Generally, Block S130 functions to implement the tangible data structure in a physical, tactile medium to enable a user to access data through a sense of touch. Block S130 can thus manipulate the dynamic tactile interface, which can include a substrate, a tactile layer, and a displacement device, as described in U.S. patent application Ser. No. 13/414,589. As shown in FIGS. 5A and 5B, the substrate can include an attachment face and a support member continuous with the attachment face, the substrate defining a portion of a cavity and a fluid channel configured to communicate fluid from the cavity through the support member; the tactile layer can define a tactile surface, the tactile layer coupled to the attachment face at an undeformable region of the tactile layer, and disconnected from the support member at a deformable region adjacent the support member, wherein the support member is configured to support the deformable region against inward deformation; and the displacement device can be configured to displace fluid through the fluid channel and toward the deformable region to transition the deformable region from a retracted setting (shown in FIG. 5A) to an expanded setting (shown in FIG. 5B) tactilely distinguishable from the retracted setting at the tactile surface. The dynamic tactile interface can further include multiple deformable regions, such as multiple adjacent deformable regions forming a tixel display, each deformable region fluidly coupled to one or more displacement devices (i.e. pumps) and controlled through one or more valves.

The dynamic tactile interface of FIGS. 5A and 5B may be provided in a variety of implementations. For example, a touch sensor of the dynamic tactile interface may be implemented between a substrate and a display or in some other location. For example, the touch sensor may be implemented between a tactile layer and a substrate, above a tactile layer, or in some other location within the dynamic tactile interface.

Block S130 can receive the tangible data structure, generated in Block S120 based on data received in Block S110, and subsequently manipulate one or more displacement devices and/or valves in the dynamic tactile interface to expand and/or retract select deformable regions according to the tangible data structure. As described above, the dynamic tactile interface can include a set of deformable regions in an array, (such as on a center console of a vehicle to communicate seat occupancy and seatbelt use), a set of strategically-placed deformable regions (such as over major cities or countries on a world globe or two-dimensional map), or a tixel display defined by a set of closely-spaced, independently-controlled deformable regions. Therefore, as described above, Block S130 can implement the tangible data structure on a dynamic tactile interface applied to a smartphone, a tablet, a watch, a vehicle console, a desktop computer, a laptop computer, a television, a PDA, a personal navigation device, a personal media or music player, a camera, a watch, a residential or commercial thermostat, a home or residential alarm system, a home or residential building or appliance monitor interface, a two-or three dimensional map, a display cabinet or display window, or any other suitable planar or curved surface.

In one variation of the method, Block S120 analyzes data received in Block S110 to specify an additional parameter of the tangible data structure. In one example implementation of this variation, Block S120 analyzes a text message, email, or other textual message received in Block S110 to determine an urgency of the message. For example, Block S120 can extract any one of the words or phrases like “hurry,” “quickly,” “ASAP,” “help!” etc. from a textual message and thus correlate the message with a high priority or urgency. Based on a determined message urgency, Block S120 can specify a temperature for one or more deformable regions of the dynamic tactile interface, wherein the temperature of the one or more deformable regions is proportional to the urgency of the message. In the example in which the computing device is a watch and the electronic device is a cellular phone, the watch can incorporate a heating element that adjusts the temperature of the dynamic tactile interface such that a user can know that he has received a message and the origin of the message (e.g., according on a “favorite” caller technique described above) based on the position of one or more deformable regions on the dynamic tactile interface and such that the user can comprehend the urgency of the message based on the temperature of one or more of the deformable regions. Alternatively, Block S120 can specify a firmness or height of one or more deformable regions of the dynamic tactile interface, wherein the firmness or height (related to fluid pressure) is proportional to the urgency of the message. In the example in which the computing device is a watch and the electronic device is a cellular phone, Block S130 can control the fluid pressure in one or more deformable regions of the dynamic tactile interface such that a user can know that he has received a message, the origin of the message (e.g., based on a “favorite” caller technique described above), and the urgency of the message based on the position and “firmness” (or height) of one or more deformable regions on the dynamic tactile interface on the watch.

Therefore, in the foregoing variation of the method, Block S130 can further control one or more heating or cooling elements arranged in the computing device to implement the additional parameter of the tangible data structure. In one example, the computing device includes a heating element in-line with the displacement device, wherein Block S130 controls power to the heating element to heat all fluid pumped into one or more deformable regions of the dynamic tactile interface. In this example, Block S130 can control heating of fluid directly before or while fluid is pumped into a cavity of a corresponding deformable region. In another example, the computing device includes one or more heating elements arranged across one or more regions of the dynamic tactile interface, wherein Block S130 controls the heating element(s) to transmit heat to the user through a subset of expanded deformable regions. In yet another example, the computing device includes one heating element per deformable region, wherein Block S130 (selectively) controls each heating element according to the additional parameter of the tangible data structure. However, Block S130 can heat all or a portion of the dynamic tactile interface of the computing device in any other way to implement the additional parameter of the tangible data structure. Furthermore, Block S130 can function in any other way to implement the deformable region settings specified in the tangible data structure by Block S120. Block S120 can also specify inward deformation of one or more deformable regions of the dynamic tactile interface, which Block S130 can further implement in the dynamic tactile layer in any suitable way.

The dynamic tactile interface may automatically change shape in response to a detected event that occurs at the remote electronic device. As such, if a particular event is detected at an external electronic device, the shape of a computing device may automatically be changed accordingly as needed. To implement this correlation, an event is detected at the remote electronic device. Upon detecting the event, data may be sent from the external electronic device to the computing device at which the deformable regions are implemented. As discussed herein, the detected events may be may be one of many types of events. An event may include detecting that a threshold has been satisfied or exceeded, such as for example an automobile achieving a speed suitable for a highway. An event may include a state change for the device, such as for example when a cell phone receives a call. An event may include an identification of something the user will need, such as for example an improved grip on a steering wheel for an upcoming portion of a road that has significant curves.

Once the event is detected, data may be sent from the remote electronic device to the computing device. As discussed above, the data may include sensor data, a data signal that does not include sensor data, one or more deformable region parameters, and/or other data. The deformable region parameters may indicate how to configure one or more deformable regions in response to detecting the event at the electronic device. Sending a deformable region parameter may be part of implementing a protocol between a remote electronic device and a computing device which implements a dynamic tactile surface as described herein. The deformable region parameters may include data regarding what deformable regions to control, as well as how to control those regions. Identifying deformable regions to control may include specifying one or more deformable regions on a particular area of a surface of the computing device. The deformable regions may be specified by location, and identifier, metadata such as urgency, priority, timeliness, and other metadata. Specifying a deformable region by urgency may include indicating whether the event is very urgent, somewhat urgent, or not urgent. Specifying a deformable region by priority may include specifying whether the event is classified as a high priority, normal priority, or low priority. Specifying a deformable region by timeliness may include specifying an event is immediate, imminent, soon, no time soon, or not associated with a deadline.

Once the data is received, the shape of the computing device surface may be changed based on the data. The shape of the data may be changed and several ways based on the data received from the external electronic device. As discussed above, a surface of the computing device may be changed by expanding the deformable region with respect to the surface of the computing device, retracting a deformable region with respect to the surface of the computing device or making a displaced deformable region flush with the surface of the computing device. The expansion, retraction, or return to flush change for the deformable region may be static in that no further action is taken unless additional data is received from the external device. Thus, once a deformable region has expanded or retracted, it will stay in that position until additional data is received to change the state of the deformable region. In some instances, the expansion, retraction, and return to flush change for the deformable region may be temporary. When a change in a deformable region is temporary, after a period of time (which may be specified in the deformable region parameter or set by default), the deformable region may return to the state at which it was prior to the most recent change. For example, if a deformable region was flush at a first point in time, the computing device received a deformable region parameter indicating that the deformable region should expand for a period of 20 seconds, the deformable region would expand for a time period of 20 seconds before it would return to a level that is flush with the surface of the computing device.

In some instances, rather than implementing a single change for a particular deformable region, a recurring or repetitive change may be implemented with one or more deformable regions. For example, when an event determined to be urgent or high priority is detected at the external electronic device, rather than simply a deformable region on a surface of the computing device, a deformable region may be repeatedly expanded and retracted to provide a pulse effect for the particular deformable region. Aspects of the pulsing motion may be controlled by deformable region parameters or other data received from the external electronic device. For example, deformable region parameters may indicate how high the deformable region should expand during the pulse activity, how low the deformable region should retracted during the pulse activity, the frequency at which the deformable region would transition between an expanded position and a retracted position, and how long the pulse would continue. For example, a pulse may expand 3 mm from the surface of a computing device and retracted to a position 1 mm above the surface of the computing device, may have a frequency of five pulses per second, and could be configured to continue pulsing for a period of five seconds.

As shown in FIG. 1, one variation of the method further includes Block S140, which recites transmitting, to the electronic device, a user response to the tangible data structure on the computing device. In one example in which the computing device is a watch and the electronic device is a smartphone, the user can select an “ignore” region on the watch (e.g., on a touchscreen arranged under the dynamic tactile interface) when a phone call is indicated on the dynamic tactile interface. Block S140 can subsequently transmit an “ignore” function to the smartphone to signal to the smartphone to cancel the call. The method can then update the dynamic tactile interface accordingly, such as by returning the dynamic tactile interface to a default setting, such as all deformable regions in the retracted setting.

In another example in which the electronic device is a home appliance and the computing device is a home monitoring interface, a touch sensor adjacent the dynamic tactile interface can record a swipe across or touch on the dynamic tactile interface. Block S140 can convert the swipe into a command to turn off a set of lights or an appliance and then transmit this command to one or more respective lights or appliances, as shown in FIG. 1. Once the state of a light or appliance changes, Block S140 can updating one or more respective deformable regions on the dynamic tactile interface accordingly. However, Block S140 can function in any other way to capture and/or implement a user response to the tangible data structure on the dynamic tactile interface of the computing device.

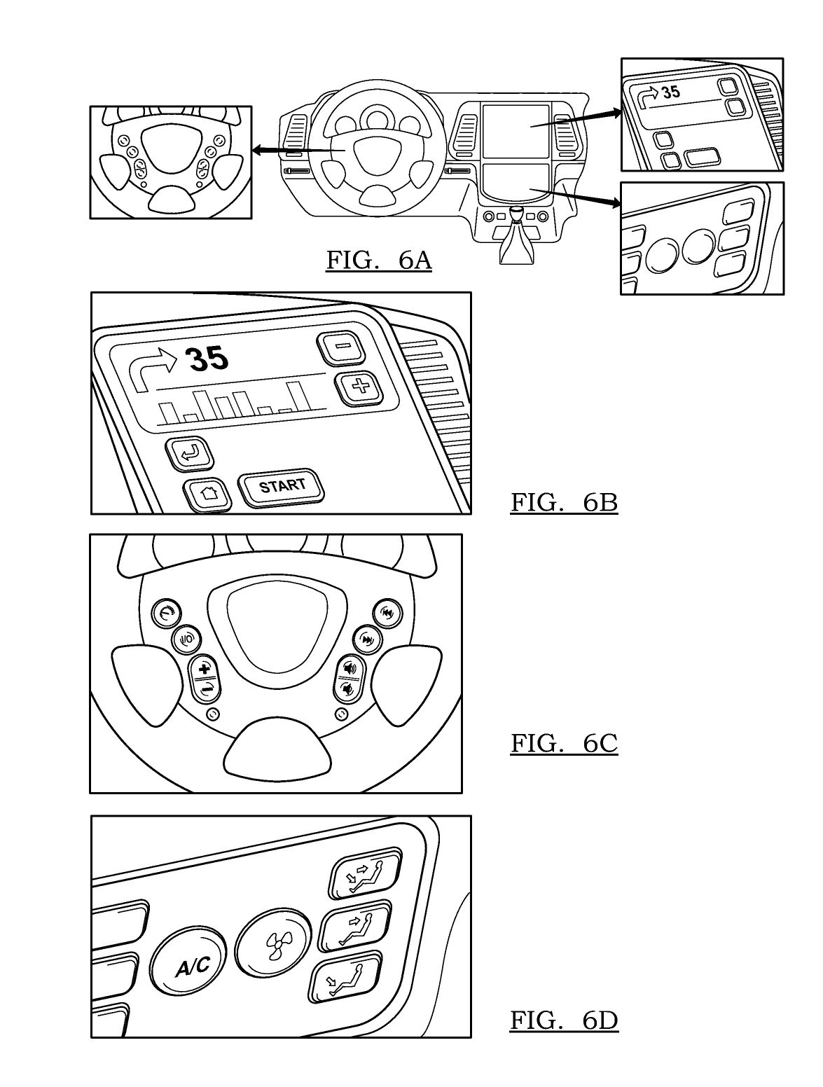

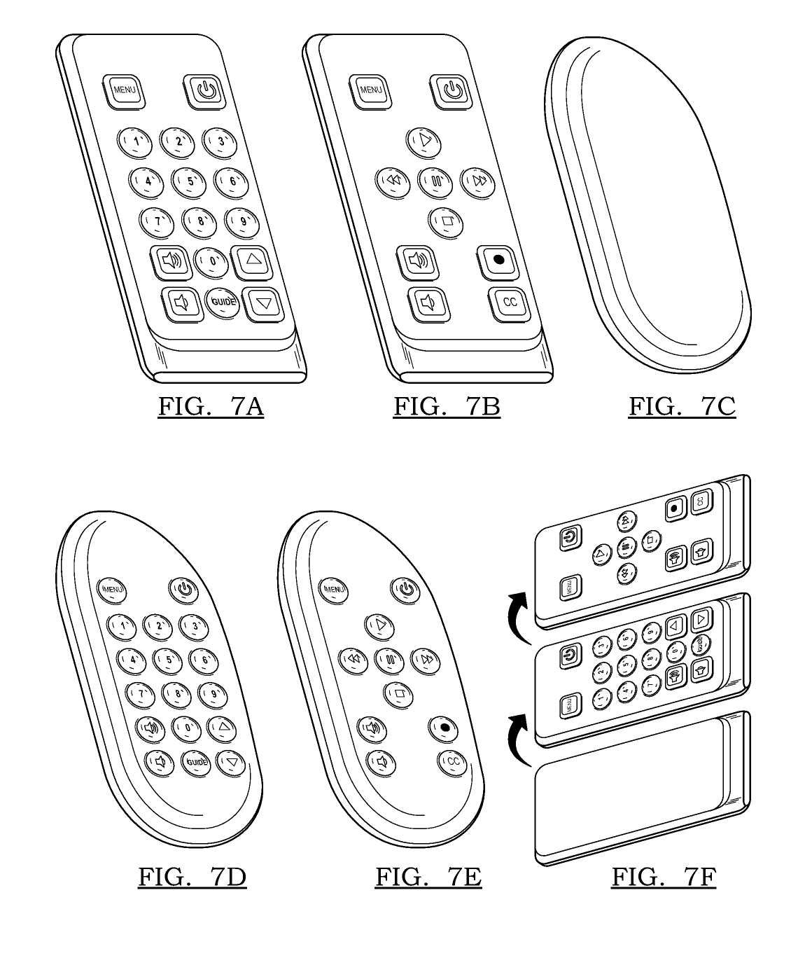

In another variation of method S100 shown in FIGS. 6 and 7, the substrate (or a portion of the substrate) of the dynamic tactile interface can be porous and substantially permeable to ink or other particulate (e.g., microscopic ink particulate) or define a set of channels, pores, and/or cavities in the substrate to support ink or other particulate. The set of channels can be disparate from the fluid channels defined by the substrate. The dynamic tactile interface can further include a reservoir supporting a volume of ink or a particulate and liquid mixture. The reservoir can be coupled to the substrate and a second displacement device configured to displace a portion of the volume of ink or the particulate and liquid mixture from the reservoir into the substrate. Thus, the second displacement device can displace ink into the substrate to selectively alter transparency (or translucency) of (a portion of) the substrate. In this variation, an electronic device can be coupled to a back surface of the substrate opposite the tactile layer. A light source (e.g., coupled to the electronic device) can be coupled to the back surface of the substrate, wherein light emitted by the light source can traverse the substrate and the tactile layer in an implementation in which the substrate and the tactile layer are substantially transparent. In this implementation, the (transparent) substrate can define one or more channels, paths, pores, and/or cavities into which the second displacement can displace ink (or other particulate) from the reservoir, the ink concentrating within in the channels, paths, pores, and/or cavities. Also in this implementation, when the ink (or other particulate) is substantially in the reservoir, the substrate can be substantially transparent, communicating light from the light source across the substrate. When the second displacement device displaces ink into the channels, paths, pores, etc., ink, which can include substantially opaque (and microscopic) particles, can transform the channels, paths, pores, etc. into a substantially opaque region. Thus, the substantially opaque region can obscure light emitted by the light source yielding a substantially opaque region of the dynamic tactile interface. Alternatively, the ink can be translucent (e.g., colored glass) particulates that can alter a color of light emitted by the light source. For example, the light source can emit substantially white light. The ink can include red (translucent) glass particles. Thus, when the second displacement device displaces ink into pores in the substrate substantially aligned with the light source, ink can function transform white light (from the light source) to substantially red light perceived by a user external the dynamic tactile interface. Furthermore, the second displacement device can selectively displace ink into a portion of the substrate aligned with a particular deformable region.

In this variation, in Block S110, the computing device can receive data from the external electronic device, the data indicating a mode or current setting of the external electronic device. For example, lack of data received from the external electronic device can indicate the external electronic device is in an “OFF” setting. In Block S120, the computing device can convert the data (or lack thereof) into a tangible data structure and a visible data structure dictating a configuration of the dynamic tactile interface. The computing device, which can include a processor coupled to the displacement device and the second displacement device, can define the tangible data structure as tactilely distinguishable deformable regions in the expanded setting. Additionally, the computing device can define the visible data structure by displacing ink from the reservoir into pores, channels, and/or cavities in the substrate to change the color or translucency of the substrate (e.g., change the substrate from translucent to substantially opaque) or displacing ink from pores, channels, and/or cavities into the reservoir to change the color or translucency of the substrate (e.g., change the substrate from opaque to substantially translucent). Thus, Block 130 can receive the tangible data structure and the visible data structure, generated in Block S120 based on data received in Block S110, and subsequently manipulate the displacement device and the second displacement device (and/or valves in the dynamic tactile interface) to expand and/or retract select deformable regions according to the tangible data structure and displace ink into (or out of) the substrate to change the translucency of the substrate according to the visible data structure. Additionally, Block S140 can convert data received in Block S110 to turn on a set of lights coupled to a back surface of the substrate, as shown in FIG. 1.

A computing device, in addition to receiving data including deformable region parameter data, may transmit data to an external electronic device. In some instances, the computing device may transmit data to an external electronic device in response to input received at a deformable region on the computing device. For example, a deformable region parameter received from an external electronic device in response to an event detected by an automobile monitoring system or speedometer. The deformable region parameter may be associated with expanding a single deformable region on the surface of a steering wheel. If a user depresses or otherwise provides input to the single expanded deformable region on the steering wheel, it can be interpreted as an indication that a user would like to utilize cruise control at the current speed at which the automobile is traveling. In response to receiving the input at the single deformable region on the steering wheel (which is provided in response to detecting a particular speed of the automobile), a processor, logic or other circuitry and/or components within the steering wheel may indicate the input selection received to the electronic device within the automobile that handles cruise control functionality. In response to that transmission, a cruise control functionality device within the automobile may provide deformable region parameters to provide one or more deformable regions on the surface of the steering wheel to enable a user to engage a cruise control feature for the automobile.

In another example, a smart appliance such as an oven may transmit a deformable region parameter to a computing device such as a smart phone with respect to the status of the oven. For example, the oven may be on while something is baking in the oven, and an oven timer may be set for a period of time. Once the timer expires, the oven may transmit a deformable region parameter to the computing device that indicates the timer has expired. The deformable region parameter may specify that a deformable region expand from the surface of the computing device, pulse for a period of time, or otherwise be configured. In the case when a deformable region expands or pulses, a user may provide input to the deformable region by touching, pressing, or swiping the deformable region, or otherwise provide an input to the computing device.

In response to the input received at the computing device, for example input received at the deformable region and provided in response to the timer expiration event, additional deformable regions may be configured to retrieve more information from a user regarding how the user would like to control the oven. For example, a first deformable region may allow the user to indicate that the oven should be turned off, while a second deformable region may allow user to indicate that the oven should remain on, while yet another deformable region may allow user to indicate that the timer should be reset for an additional period of time. Upon receiving input from a user at one of the additional deformable regions, the computing device may send data to the external electronic device—the oven—based on the user input. The data sent to the external electronic device may control an aspect of electronic device based on the user's input. For example, if the user selects a first additional deformable region indicating that the oven should be turned off, the data sent to the external electronic device from the computing device will include an instruction to turn the oven off. If the user selects an additional deformable region indicating that the oven should remain on, the data sent to the external electronic device from the computing device will include an instruction to leave the oven on. If the user selects an additional deformable region indicating that the oven should remain on and a time or should be set for a particular period of time, the data will include instructions to set the oven timer for the particular period of time. In response to the computing device sending data such as an instruction to the external electronic device, the electronic device may in turn send a deformable region parameter to the computing device as a confirmation message. The deformable region parameter that implements a confirmation message may configure one or more deformable regions to deform, such as for example to have a deformable region pulse for a short period of time, to acknowledge that the oven received and implemented the instruction.

In one example of the foregoing variation, the computing device can include a remote control (e.g., a consumer infrared device) for controlling the external electronic device, such as a television, a digital versatile disc player, or other device remote from the remote control. In Block S110, the remote control can detect data from the television. In this example in Block S110, the remote control can detect the television in the “OFF” setting. The remote control can additionally detect a user proximal the remote control, as described in U.S. patent application Ser. No. 14/471,889, which is incorporated in its entirety by this reference. When the user is remote from the remote control, the remote control can be in a first setting (e.g., in which the remote is in an “OFF” state), in which the deformable region(s) are in the retracted setting and the remote control appears substantially opaque. When the remote control detects the user proximal the remote (e.g., holding the remote), the remote can transition to a second setting in which the remote detects the television in the “OFF” setting. Thus, in Block S120, the remote can the data received from the television (i.e., data which indicates the television is in the “OFF” setting) and convert the data to a tangible and visible data structure. The tangible and visible data structure can include a tactilely distinguishable button of a substantially round cross-section display a red “Power” icon aligned with a center of the tactilely distinguishable button. Therefore, Block S130 can define tactilely distinguishable deformable regions and alter the color or translucency of a portion of the substrate. Thus, a user may depress the tactilely distinguishable button, thereby turning the television on. Once the television is on, the remote can detect a state of the television (e.g., on and displaying a sports broadcasting channel and emitting particular volume). Block S120 can convert data received from the television and convert the data into a tangible and visible data structure defining volume change buttons, channel change buttons, a power icon, a “mode” button, etc. Thus, in Block S130, the displacement device can displace fluid into the fluid cavities to transition deformable region corresponding to and substantially aligned with locations for the channel change buttons, volume change buttons, the power icon, etc. Likewise, in Block S130, the second displacement device can displace ink into the substrate coincident the deformable region to effectively print corresponding icons for the volume change buttons, channel change buttons, and the power icon adjacent or coincident respective deformable regions. Thus, method S100 can function to define a dynamically reconfigurable tactile and visual remote without necessitating a liquid-crystal display.

Block S120 can analyze data received in Block S110 to specify a mass of the tangible data structure. Block S130 of the method recites outwardly deforming a portion of a dynamic tactile layer corresponding to the tangible data structure, the dynamic tactile layer arranged on a surface of the computing device and including a set of deformable regions, each deformable region configured to deform into an elevated tactile formation, the portion of the dynamic tactile layer including a subset of deformable regions in the set of deformable regions.

The systems and methods of the embodiments can be embodied and/or implemented at least in part as a machine configured to receive a computer-readable medium storing computer-readable instructions. The instructions can be executed by computer-executable components integrated with the application, applet, host, server, network, website, communication service, communication interface, hardware/firmware/software elements of a user computer or mobile device, or any suitable combination thereof. Other systems and methods of the embodiments can be embodied and/or implemented at least in part as a machine configured to receive a computer-readable medium storing computer-readable instructions. The instructions can be executed by computer-executable components integrated by computer-executable components integrated with apparatuses and networks of the type described above. The computer-readable medium can be stored on any suitable computer readable media such as RAMs, ROMs, flash memory, EEPROMs, optical devices (CD or DVD), hard drives, floppy drives, or any suitable device. The computer-executable component can be a processor, though any suitable dedicated hardware device can (alternatively or additionally) execute the instructions.

As a person skilled in the art will recognize from the previous detailed description and from the figures and claims, modifications and changes can be made to the embodiments of the invention without departing from the scope of this invention as defined in the following claims.

I claim:

1. A method for tactilely outputting data on a device, comprising;
receiving data by a processor on a second device from an external device, the data including a deformable region parameter;
converting, by the processor, the data into a tangible data structure based on the deformable region parameter; and
deforming a portion of a dynamic tactile layer on the second device corresponding to the tangible data structure,
the dynamic tactile layer arranged over a surface of the second device and including a set of deformable regions, each deformable region configured to deform into an elevated or recessed tactile formation, the portion of the dynamic tactile layer including a subset of deformable regions in the set of deformable regions.

2. The method of claim 1, wherein deforming includes expanding the portion of the dynamic tactile layer into an elevated tactile formation.

3. The method of claim 1, wherein deforming includes retracting the portion of the dynamic tactile layer into a recessed tactile formation.

4. The method of claim 1, wherein deforming includes continuously expanding the portion of the dynamic tactile layer and then reducing the portion of the dynamic tactile layer to provide a pulsing deformable region.

5. The method of claim 1, wherein deforming includes:
displacing fluid through a fluid vessel by a displacement device to deform the portion of the dynamic tactile layer, the fluid vessel located beneath the surface of the second device.

6. The method of claim 1, wherein the second device includes a computing device.

7. The method of claim 1, wherein the second device includes a vehicle steering device.

8. The method of claim 1, wherein the second device includes a device that is worn by a user.

9. The method of claim 1, wherein deforming a portion of the dynamic tactile layer includes:
deforming a first portion of the dynamic tactile layer; and
detecting an input applied by a user at the first portion of the dynamic tactile layer.

10. The method of claim 9, further comprising deforming a second portion of the dynamic tactile layer in response to the detected input.

11. The method of claim 9, further comprising deforming the first portion of the dynamic tactile layer in response to the detected input.

12. The method of claim 9, further comprising transmitting data from the second device to the external device in response to detecting the input applied at the first portion of the dynamic tactile layer.

13. The method of claim 9, further comprising transmitting data to the second device in response to detecting the input applied at the first portion of the dynamic tactile layer.

14. The method of claim 1, wherein the tangible data structure includes an instruction to deform the portion of the dynamic tactile layer.

15. The method of claim 1, wherein the second portion includes a plurality of discrete portions of the dynamic tactile layer.

16. The method of claim 1, wherein the deformable region parameter includes a deformable region identifier.

17. The method of claim 1, wherein the deformable region parameter includes a deformable region height or pressure value.

18. The method of claim 1, wherein the deformable region parameter includes a time period over which the deformable region will expand.

19. The method of claim 1, wherein the deformable region parameter includes a time period for which the deformable region remains expanded.

20. The method of claim 1, wherein the deformable region parameter includes a deformable region firmness value.

21. The method of claim 1, wherein the deformable region parameter includes a deformable region temperature value.

22. The method of claim 1, wherein the deformable region parameter includes a deformable region pulsing speed value.

23. The method of claim 1, wherein the deformable region parameter includes a return value associated with the deformable region, the return value transmitted to the external electronic device in response to input received at the deformable region.

24. A method for tactilely displaying data on a device, comprising;
receiving data by a processor from an external device;
converting, by the processor, the data into a tangible data structure; and
deforming a portion of a dynamic tactile layer corresponding to the tangible data structure,
the dynamic tactile layer arranged over a surface of a second device and including a set of deformable regions, each deformable region configured to deform into an elevated or recessed tactile formation, the portion of the dynamic tactile layer including a subset of deformable regions in the set of deformable regions.

25. The method of claim 24, wherein the external device has a plurality of states.

26. The method of claim 25, wherein the state includes a power setting.

27. The method of claim 25, wherein the state is based on detection of an event at the external device.

28. The method of claim 25, wherein deforming includes expanding the portion of the dynamic tactile layer into an elevated tactile formation.

29. The method of claim 25, wherein deforming includes retracting the portion of the dynamic tactile layer into a recessed tactile formation.

30. The method of claim 24, wherein deforming includes continuously expanding the portion of the dynamic tactile layer and then reducing the portion of the dynamic tactile layer to provide a pulsing deformable region.

31. The method of claim 24, wherein deforming includes:
displacing fluid through a fluid vessel by a displacement device to deform the portion of the dynamic tactile layer, the fluid vessel located beneath the surface of the second device.

32. The method of claim 24, wherein the second device includes a computing device.

33. The method of claim 24, wherein the second device includes a vehicle steering device.

34. The method of claim 24, wherein the second device includes a device that is worn by a user.

35. The method of claim 24, wherein deforming a portion of the dynamic tactile layer includes:
deforming a first portion of the dynamic tactile layer; and
detecting an input applied by a user at the first portion of the dynamic tactile layer.

36. The method of claim 35, further comprising deforming a second portion of the dynamic tactile layer in response to the detected input.

37. The method of claim 35, further comprising deforming the first portion of the dynamic tactile layer in response to the detected input.

38. The method of claim 35, further comprising transmitting data from the second device to the external device in response to detecting the input applied at the first portion of the dynamic tactile layer.

39. The method of claim 35, further comprising transmitting data to the second device in response to detecting the input applied at the first portion of the dynamic tactile layer.

40. The method of claim 32, wherein the tangible data structure includes an instruction to deform the portion of the dynamic tactile layer.

41. A user interface system, comprising;
a processor receiving data from an external device and converting the data into a tangible data structure, the data including a deformable region parameter, the converting based on the deformable region parameter.
a substrate;
a dynamic tactile layer arranged over a surface of a second device and including a set of deformable regions and peripheral regions, each deformable region coupled to the substrate at the peripheral regions and configured to deform into an elevated or recessed tactile formation, a portion of the dynamic tactile interface deformed corresponding to the tangible data structure, the portion of the dynamic tactile layer including a subset of deformable regions in the set of deformable regions;

42. A user interface system, comprising;
a processor receiving data from an external device and converting the data into a tangible data structure, the converting based on the deformable region parameter.
a substrate;
a dynamic tactile layer arranged over a surface of a second device and including a set of deformable regions and peripheral regions, each deformable region coupled to the substrate at the peripheral regions and configured to deform into an elevated or recessed tactile formation, a portion of the dynamic tactile interface deformed corresponding to the tangible data structure, the portion of the dynamic tactile layer including a subset of deformable regions in the set of deformable regions;
